(19) United States
(12) Patent Application Publication
(10) Pub. No.: US 2025/0357878 A1
(43) Pub. Date: Nov. 20, 2025

(54) SYSTEM AND METHOD FOR HIGH EFFICIENCYCLOSED-LOOP STARTUP FOR SENSORLESS MOTOR DRIVE

(71) Applicant: Nidec Motor Corporation, St. Louis, MO (US)

(72) Inventors: Nektarios Karakasis, Markopoulo (GR); Athanasios Sarigiannidis, Markopoulo (GR); Nikolaos Tsakalakis, Markopoulo (GR); Steven C. Bartz, Eden Prairie, MN (US)

(73) Assignee: Nidec Motor Corporation, St. Louis, MO (US)

(21) Appl. No.: 19/064,903

(22) Filed: Feb. 27, 2025

(30) Foreign Application Priority Data
May 17, 2024 (GR) 20240100372

(51) Int. Cl. H02P 21/34; H02P 21/14; H02P 21/24; H02P 25/022

(52) U.S. Cl. CPC H02P 21/34; H02P 21/14; H02P 21/24; H02P 25/022

(57) ABSTRACT

A system and method for closed-loop startup for a sensorless permanent magnet motor drive are disclosed. The drive provides an output current to a motor. A closed-loop startup subsystem includes a proportional integral closed-loop controller determining an optimal current command to maintain synchronization of the motor during a change in speed. The controller is configured to determine a power difference between an actual motor power output and an ideal motor power output, determines the optimal electric current command based on the power difference, and apply the optimal electric current command to adjust the output current to reduce the power difference. The controller may include an acceleration feedforward mechanism configured to determine and add an acceleration feedforward current component to the output electric current to compensate for the effects of inertia and friction. Additionally, for each torque current command applied, the controller may add a q-axis current offset.

### RELATED APPLICATIONS

The present U.S. non-provisional patent application is related to and claims priority benefit of a prior-filed Greek patent application titled “High Efficiency Closed-Loop Startup for Sensorless Permanent Magnet Motor Drive,” application No. 20240100372, filed May 17, 2024. The entire content of the identified earlier-filed application is incorporated by reference as though fully set forth herein.

### FIELD

The present invention relates to systems and methods for controlling the operations of electric motors, and more particularly, embodiments concern a system and method for closed-loop startup for a sensorless permanent magnet motor drive.

### BACKGROUND

Sensorless permanent magnet motors (PM motors or PMMs) are useful in various applications due to their high efficiency, compact size, and robust performance. However, challenges with these motors include that the startup phase is executed without the aid of position sensors to determine the rotor position for efficient control. Conventional startup techniques generally rely on open-loop control methods, which may lead to inaccuracies in rotor position estimation, especially at zero or low speeds. These inaccuracies can result in a loss of control and desynchronization of the PMM. This is a significant limitation because accurate rotor position information is desirable for optimal motor control.

Current sensorless methods can accurately determine the rotor position only once the motor reaches a certain rotational speed. Below this speed, many systems employ “forced commutation” in which the rotor position is unknown and a sufficiently high current is applied to ensure that the rotor's magnets follow the rotating magnetic field created by the windings. However, if the current is too low, the rotor magnets may not align properly with the rotating field, leading to desynchronization between the rotor position and the phase switching of the motor. This desynchronization can cause the motor to run inefficiently and may lead to increased vibration and noise. Conversely, if the current is too high, the motor may operate inefficiently and oscillate, especially during the transition from forced commutation to sensorless commutation. Further, when the motor controller detects the rotor position at higher speeds and switches from forced to sensorless commutation, any excess current initially used for forcing the commutation can lead to torque overshoot. This overshoot manifests as mechanical noise and potentially harmful vibrations as the motor rapidly adjusts to the correct commutation based on the actual rotor position.

Conventional startup strategies have been developed focusing on enhancing efficiency, reducing power loss, and improving the stability and robustness of the motor drive during the startup phase. These strategies include the implementation of various closed-loop control methods, such as those utilizing output power minimization. These strategies aim to regulate the motor current more accurately, thereby optimizing performance. A smoother transition process aids in maintaining the motor's efficiency and stability, thereby enhancing the overall performance of the drive system.

This background discussion is intended to provide information related to the present invention which is not necessarily prior art.

### SUMMARY

Embodiments of the present invention address the above-described and other problems and limitations in the prior art by providing a system and method for closed-loop startup for a sensorless PMM drive. Broadly, embodiments advantageously facilitate more efficiently operating an electric motor during a transition from forced commutation to sensorless commutation, more accurately determining a position of a rotor of the motor while optimally managing an electric current applied to the motor, and providing smoother operation of the motor and synchronization with desired speed and torque settings.

In a first embodiment of the present invention, a system may include a sensorless motor drive and a closed-loop startup subsystem. The sensorless motor drive may be configured to provide an output electric current to an electric motor. The closed-loop startup subsystem may include a proportional integral (PI) closed-loop controller configured to determine an optimal electric current command to maintain a synchronization of the electric motor during a change in speed. The PI closed-loop controller may be configured to perform at least the following functions: determining a power difference between an actual direct current (DC) power consumption of the electric motor and an ideal motor power output of the electric motor, determining the optimal electric current command based on the power difference, and applying the optimal electric current command to adjust the output electric current to the electric motor to reduce the power difference.

Various implementations of the first embodiment may include any one or more of the following features. The closed-loop startup subsystem may only operate when a speed of the electric motor is between zero (0) revolutions per minute (RPM) and four hundred (400) RPM. Determining the power difference may include measuring the actual DC power consumption on a DC bus which is coupled with the electric motor; determining an actual motor power output based on the actual direct current power consumption and a calculated converter and motor copper losses; determining the ideal motor power output of the electric motor as a function of at least the output electric current from the sensorless motor drive, a torque constant of the electric motor, and a rotational speed of the electric motor, and assuming that a rotor is running synchronously with a magnetic field within the electric motor; and comparing the actual motor power output to the ideal motor power output of the electric motor to determine the power difference. The PI closed-loop controller may include an acceleration feedforward mechanism configured to determine an acceleration feedforward electric current component and add the acceleration feedforward electric current component to the output electric current of the PI closed-loop controller; wherein the acceleration feedforward current component is determined as a function of a mechanical system inertia, a rotating friction coefficient, a mechanical speed, and a torque constant of the electric motor; and wherein the acceleration feedforward current component acts as a feedforward parameter that is adjusted to compensate for an effect of inertia and friction and thereby maintain a synchronization of the electric motor during the change in its speed. The PI closed-loop controller may add to the optimal electric current command a q-axis current offset of between three (3) and eight (8) percent of a maximum value of the output electric current.

In a second embodiment of the present invention, a system may include an PM motor, a sensorless PMM drive and a closed-loop startup subsystem. The PM motor may include a rotor, a stator, and a shaft for driving a load. The sensorless PMM drive may provide an output electric current to the PM motor. The closed loop startup subsystem may include a PI closed-loop controller configured to determine an optimal electric current command to maintain a synchronization of the PM motor during a change in a speed of the PM motor. The PI closed-loop controller may be configured to perform at least the following functions including determining a power difference between an actual motor power output and an ideal motor power output of the PM motor, determining the optimal electric current command based on the power difference, and applying the optimal electric current command to adjust the output electric current to the PM motor to reduce the power difference.

Various implementations of the second embodiment may include any one or more of the following features. The closed-loop startup subsystem may only operate when a speed of the PM motor is between zero (0) RPM and four hundred (400) RPM. Determining the power difference may include measuring the actual DC power consumption on a DC bus which is coupled with the PM motor; determining an actual motor power output based on the actual direct current power consumption and a calculated converter and motor copper losses; determining the ideal motor power output of the PM motor as a function of at least the output electric current from the sensorless PMM drive, a torque constant of the PM motor, and a rotational speed of the PM motor, and assuming that a rotor of the PM motor is running synchronously with a magnetic field within the PM motor; and comparing the actual motor power output to the ideal motor power output of the PM motor to determine the power difference. The PI closed-loop controller may include an acceleration feedforward mechanism configured to determine an acceleration feedforward electric current component and add the acceleration feedforward electric current component to the output electric current of the PI closed-loop controller. The acceleration feedforward current component may be determined as a function of a mechanical system inertia, a rotating friction coefficient, a mechanical speed, and a torque constant of the PM motor; wherein the acceleration feedforward current component acts as a feedforward parameter that is adjusted to compensate for an effect of inertia and friction and thereby maintain a synchronization of the PM motor during the change in the speed of the PM motor; and wherein the acceleration feedforward current component acts as a feedforward parameter that is adjusted to compensate for an effect of inertia and friction and thereby maintain a synchronization of the electric motor during the change in its speed. The PI closed-loop controller may add to the optimal electric current command a q-axis current offset of between three (3) and eight (8) percent of a maximum value of the output electric current.

In a third embodiment of the present invention, a method may include at least the following steps. An output electric current may be provided to an electric motor with a sensorless PMM drive. The output electric current to the electric motor may be adjusted. The operation of adjusting the output electric current may include determining an optimal electric current command to maintain a synchronization of the electric motor during a change in a speed of the electric motor. The operation of determining the optimal electric current command includes determining a power difference between an actual motor power output and an ideal motor power output of the electric motor, determining the optimal electric current command based on the power difference, and applying the optimal electric current command to adjust the output electric current to the electric motor to reduce the power difference.

Various implementations of the third embodiment may include any one or more of the following features. Adjusting the output electric current may occur only when a speed of the electric motor is between zero (0) RPM and four hundred (400) RPM. The operation of determining the power difference may include measuring the actual DC power consumption on a DC bus which is coupled with the electric motor; determining an actual motor power output based on the actual direct current power consumption and a calculated converter and motor copper losses; determining the ideal motor power output of the electric motor as a function of at least the output electric current from the sensorless motor drive, a torque constant of the electric motor, and a rotational speed of the electric motor, and assuming that a rotor of the electric motor is running synchronously with a magnetic field within the electric motor; and comparing the actual motor power output to the ideal motor power output of the electric motor to determine the power difference. The method may further include determining an acceleration feedforward electric current component and adding the acceleration feedforward electric current component to the output electric current, wherein the acceleration feedforward current component is determined as a function of a mechanical system inertia, a rotating friction coefficient, a mechanical speed, and a torque constant of the electric motor, and the acceleration feedforward current component acts as a feedforward parameter that is adjusted to compensate for an effect of inertia and friction and thereby maintain a synchronization of the electric motor during the change in its speed. The method may further include adding to the optimal electric current command a q-axis current offset of between three (3) and eight (8) percent of a maximum value of the output electric current.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a block of diagram of an embodiment of a system for closed-loop startup for a sensorless PMM drive;

FIG. 2 is a flow diagram of functions performed by the system of FIG. 1;

FIG. 3 is a flowchart of operations in an embodiment of a method for closed-loop startup for a sensorless PMM drive;

FIG. 4 is a comparison of the performance of the system and method of the preferred embodiment and the performance of a conventional open-loop control system during transition from startup to closed-loop speed control; and

FIG. 5 is a comparison of the performance of the system and method of the preferred embodiment and the performance of the conventional open-loop control system during constant speed and under various applied loads.

The figures are not intended to limit the present invention to the specific embodiments they depict. The drawings are not necessarily drawn to scale.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, procedural, operational, and other changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. Similar structures or components in the various drawings may retain the same or similar numbering for the convenience of the reader; however, any similarity in numbering does not necessarily mean that the structures or components are necessarily identical in size, composition, configuration, or any other property.

Terms of relative location and direction (for example, above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

Thus, it will be readily understood that the components of the examples as generally described herein and illustrated in the drawings could be arranged and designed in a wide variety of different configurations. Thus, the following description of various examples is not intended to limit the scope of the present disclosure but is merely representative of various examples.

During a sensorless startup process in an electric motor drive, which typically occurs from zero (0) RPM to approximately between three hundred (300) and four hundred (400) RPM, the angle to drive the system is estimated rather than known. However, the angle cannot be accurately estimated, which can result in inefficiency and both torque and speed overshoots. After startup, sensorless control is more accurate and reliable. In particular, in scenarios with aggressive transitions, the resulting currents can exceed corresponding load currents and, as a result, an overshoot in torque and/or speed occurs. As a result, for many applications with aggressive acceleration profiles, such as marine and semi-servo systems, conventional startup methods may be impractical. One solution is to use a reference current, in an open-loop process, until sensorless control becomes accurate and is reliable. However, this solution is also relatively inaccurate, requires a relatively high reference current, and has difficulty transitioning to sensorless control.

Broadly, embodiments provide a more accurate, reliable, and efficient startup sensorless control system and method for a sensorless PMM drive for relatively low speeds, from zero (0) RPM to approximately between three hundred (300) and four hundred (400) RPM). Further, embodiments are capable of bypassing a high torque demand (due, for example, to a propeller being stuck in weeds). Additionally, embodiments are capable of accommodating a high acceleration rate up to a rated speed with a smooth transition from open-loop startup to closed-loop field-oriented control (FOC) sensorless techniques. Embodiments estimate an optimal reference current to deliver to the open-loop startup process to minimize power loss and maximize efficiency during startup and low speed operation. Embodiments advantageously lower output power, thereby reducing the necessary current for the desired load torque. A closed-loop PI regulator maintains steady current levels for various load and speed levels, utilizing feedback from the motor's output power. Additionally, an acceleration feedforward element refines the control's response during speed transitions. Embodiments effectively reduce the losses typically seen in open-loop sensorless startups, particularly in scenarios where sensorless FOC models are inadequate for position estimation at zero or low speeds. The transition from open-loop to closed-loop sensorless control is made more seamless and dependable, ensuring that the motor current remains close to the ideal value, which can include a specified value and/or a required value. Embodiments outperform conventional open-loop startup methods both in dynamic and in steady-state operating conditions. Potential applications for embodiments of the present invention include variable speed drive applications, such as propulsion marine and water boat applications.

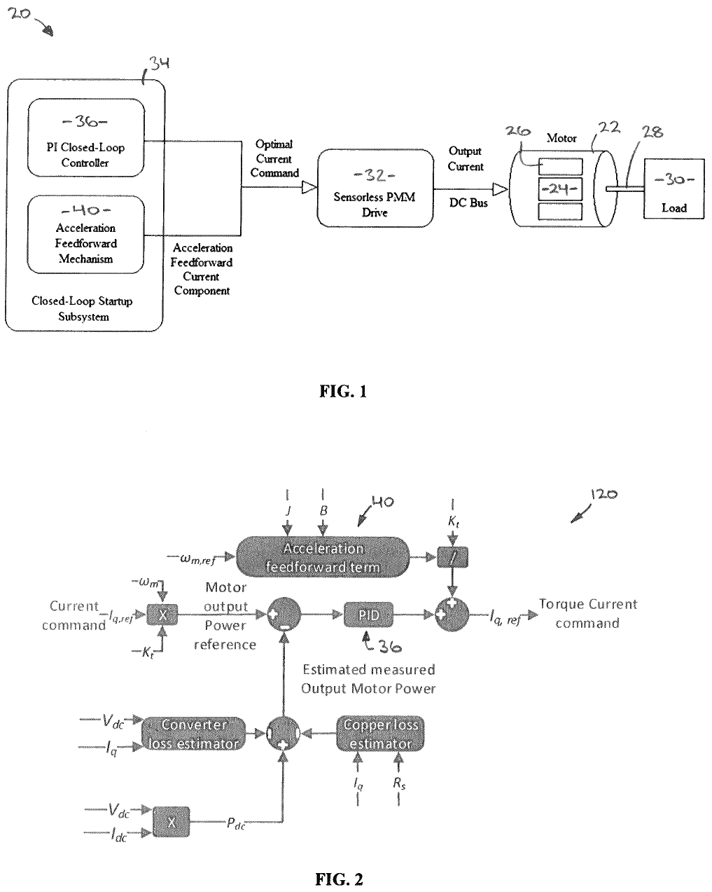

Referring to FIG. 1, an embodiment of a system 20 is shown for high efficiency closed-loop startup for a sensorless PMM drive. The system 20 and its operational environment may broadly include an electric motor 22 including a rotor 24, a stator 26, and a shaft 28 for driving a load 30; the sensorless PMM drive 32; and a closed-loop startup subsystem 34. The electric motor 22 may be a PM motor. The sensorless PMM drive 32 may be configured to provide an output electric current to the electric motor 22.

The closed-loop startup subsystem 34 may include a PI closed-loop controller 36 configured to determine an optimal electric current command and to maintain a synchronization of the electric motor 22 during changes in a speed of the electric motor 22. In one implementation, the PI closed-loop controller 36 may calculate or otherwise determine a power difference (or inefficiency) between an actual DC power consumption and a calculated ideal motor power output of the electric motor 22, and may then determine the optimal electric current command based on the determined power difference. The PI closed-loop controller 36 may then apply the optimal electric current command to adjust the output electric current to the electric motor 22 to reduce the determined power difference.

In a more detail, an implementation of the PI closed-loop controller 36 may measure the actual DC power consumption on a DC bus, which is coupled with the electric motor 22, and may then estimate or otherwise determine the calculated ideal motor power output of the electric motor 22. The ideal motor power output may be determined based on or as a function of the output electric current from the sensorless PMM drive 32, a motor torque constant (Kt) of the electric motor 22, and a rotational speed of the electric motor 22, and by assuming that the rotor 24 is running synchronously with a magnetic field within the electric motor 22. When the electric motor 22 is operating efficiently, the calculated ideal motor power output should approximately match the actual DC power consumption from the DC bus, adjusted for any losses in the PMM drive 32 and the electric motor 22. The PI closed-loop controller 36 may then compare the actual motor power output, which may be determined based on the DC power consumption and the calculated converter and motor copper losses, to the calculated ideal motor power output of the electric motor 22 to determine the power difference between the actual and the ideal motor power outputs of the electric motor 22, and may then determine the optimal electric current command based on the determined power difference. The PI closed-loop controller 36 may then apply the optimal electric current command to adjust the output electric current to the electric motor 22 to reduce the determined power difference so that the electric motor 22 operates more efficiently without experiencing speed or torque overshoot.

In one implementation, the PI closed-loop controller 36 may include an acceleration feedforward mechanism 40 configured to estimate or otherwise determine an acceleration feedforward electric current component. The PI closed-loop controller 36 may add the acceleration feedforward electric current component to the output electric current of the PI closed-loop controller 38. The acceleration feedforward current component may be estimated or otherwise determined based on or as a function of a mechanical system inertia, a rotating friction coefficient, a mechanical speed, and the motor torque constant. The acceleration feedforward current component may act as a feedforward parameter that is proactively adjusted to compensate for anticipated effects of inertia and friction, thereby maintaining a synchronization of the electric motor 22 with speed and torque settings during changes in the speed of the electric motor 22.

In one implementation, for each output electric current command applied, the PI closed-loop controller 36 may add an additional q-axis current offset of approximately between three (3) and eight (8) percent, or approximately five (5) percent, of a maximum value of the output electric current.

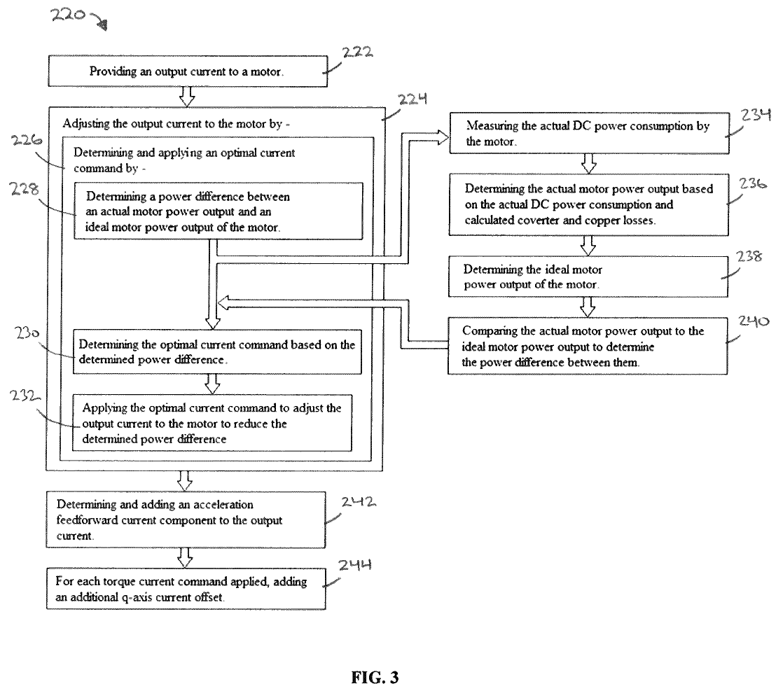

Referring also to FIG. 2 a flow diagram of functions 120 that may be performed by the system of FIG. 1 is shown, wherein
J is the mechanical system inertia,
B is the rotating friction coefficient,
ωₘ is the mechanical speed,
Kₜ is the motor torque constant,
I_{q,ref} is the commanded torque current,
I_{q} is the measured torque current,
V_{dc}, I_{dc}, P_{dc} are the input de voltage current, and power, respectively, and
Rs is the stator resistance.

The acceleration feedforward mechanism 40 may estimate the required current based on the mechanical system characteristics. This current is added to the output current from the PI closed-loop controller 36. The acceleration feedforward current component, I_{qFF}, may be determined as follows:

$${I}_{qFF} = \frac{J \frac{d {ω}_{m}}{dt} + B {ω}_{m}}{{K}_{t}}$$

Embodiments stabilize the calculated output motor power to the optimum motor output based on the current command applied. This can be derived from the torque constant of the motor, given that the whole input power supplies the optimum motor torque for that current. In order to be able to estimate the measured motor output power, the input DC power is needed, as well as the motor drive losses, which mainly comprises the converter losses and the copper losses. The total converter losses P_{conv}, employing both conduction and switching losses, may be determined as follows:

$${P}_{conv} = {P}_{1} {I}_{q}^{2} + {P}_{2} {I}_{q} {V}_{dc}$$

where P₁ and P₂ are loss coefficients which are calculated experimentally. The copper losses P_{cu} are determined as follows:

$${P}_{cu} = \frac{3}{2} {R}_{s} {I}_{q}^{2}$$

Additionally, for each output current command applied, an additional q-axis current offset of approximately between three (3) and eight (8) percent, or approximately five (5) percent, of the maximum motor drive current may be applied for stability purposes, ensuring that the synchronous spinning reference frame d′-q′ lags the actual rotor d-q frame.

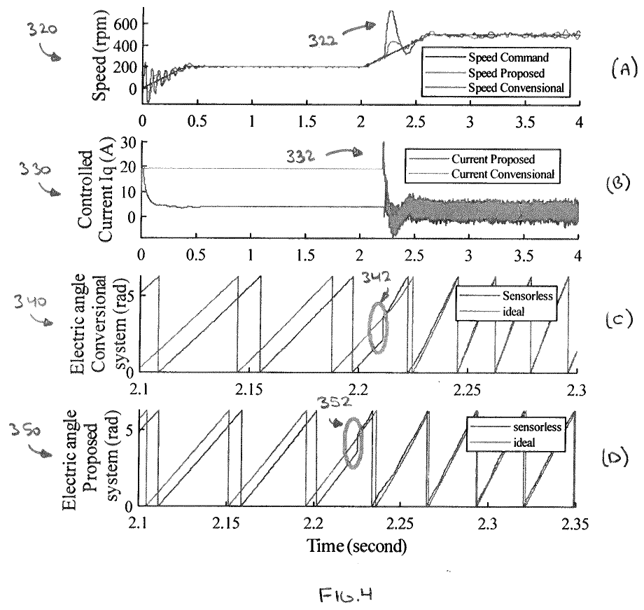

Referring to FIG. 3, an embodiment of a method 220 is shown for providing high efficiency closed-loop startup for a sensorless PMM drive. The method 120 may include the operations set forth below. Reference is made to the embodiment of the system 20 of FIGS. 1 and 2 that may be used to perform the method 220. Broadly, the output electric current may be provided to the electric motor 22 with the sensorless PMM drive 32, as shown in 222. The output electric current provided to the electric motor 22 may be adjusted with a closed-loop startup subsystem 34 for the sensorless PMM drive 32, as shown in 224.

In one implementation, adjusting the output electric current may include the following steps. An optimal electric current command may be determined and applied to maintain a synchronization of the electric motor 22 during changes in a speed of the electric motor 22, as shown in 226. The optimal electric current command is preferably determined and applied by the PI closed-loop controller 36, in accordance with the steps as follows. A power difference between an actual motor power output and an ideal motor power output of the electric motor 22 may be calculated or otherwise determined, as shown in 228. The optimal electric current command may be determined based on the determined power difference, as shown in 230. The optimal electric current command may be applied to adjust the output electric current to the electric motor 22 to reduce the determined power difference so that the electric motor 22 operates more efficiently without experiencing torque overshoot, as shown in 232.

In one implementation, determining the power difference, as shown in 228, may include the following steps. The actual DC power consumption on the DC bus which is coupled with the electric motor 22 may be measured, as shown 234. The actual motor power output may be determined based on the actual DC power consumption and calculated converter and motor copper losses, as shown in 236. The ideal motor power output of the electric motor 22 may be estimated or otherwise determined, as shown in 238, based on the output electric current from the sensorless PMM motor drive 32, the torque constant (Kt) of the electric motor 22, and a rotational speed of the electric motor 22, and by assuming that the rotor 24 is running synchronously with a magnetic field within the electric motor 22. When the electric motor 22 is operating efficiently, the ideal motor power output should match the actual DC power consumption from the DC bus, adjusted for any losses in the PI closed-loop controller 36 and the electric motor 22. The actual motor power output may be compared to the calculated ideal motor power output of the electric motor 22 to determine the power difference (or inefficiency) between the actual DC power consumption and a calculated ideal motor power output of the electric motor 22, as shown in 240. The optimal electric current command may then be determined based on the determined power difference, as shown in 232.

In one implementation, the PI closed-loop controller 36 may include the acceleration feedforward mechanism 40, and the method 220 may further include additional steps to estimate or otherwise determine and add the acceleration feedforward electric current component to the output electric current of the PI closed-loop controller 36, as shown in 242. The acceleration feedforward current component may be determined based on or as a function of the mechanical system inertia, the rotating friction coefficient, the mechanical speed, and the motor torque constant. The acceleration feedforward current component may act as a feedforward parameter which is proactively adjusted to compensate for anticipated effects of inertia and friction and thereby maintain a synchronization of the electric motor 22 with speed and torque settings during changes in the speed of the electric motor 22.

In one implementation, for each torque current command applied, an additional q-axis current offset of approximately between three (3) and eight (8) percent, or approximately five (5) percent, of a maximum value of the output electric current may be added with the PI closed-loop controller 36, as shown in 244.

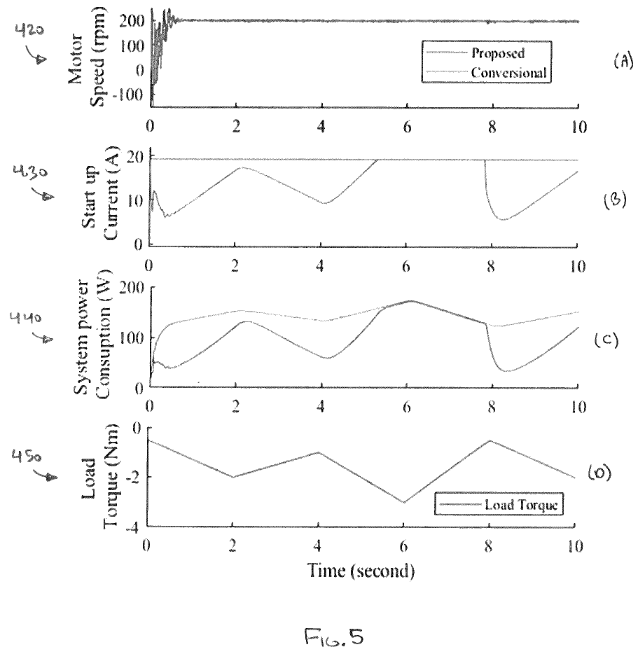

Referring to FIG. 4, the performance of the embodiments of the system 20 and method 220 of the present invention is compared with the performance of a conventional system and method during startup acceleration. More specifically, as seen in FIG. 4(A), a graph 320 of motor speed (in RPM) versus time (in seconds) shows that exemplary embodiments significantly reduce speed fluctuations 322 at low speeds and during transition from open-loop to closed-loop control (which occurs at 200 RPM in this example) when compared to a conventional technique. As seen in FIGS. 4(B), (C), and (D), embodiments minimize q-axis current undershoot and settling time during transition from open-loop to closed-loop control. More specifically, in FIG. 4(B), a graph 330 of current, Iq, (in amperes) versus time (in seconds) shows that embodiments significantly reduce current fluctuations 332 at low speeds and during transition from open-loop to closed-loop control when compared to the conventional technique. In FIG. 4(C), a graph 340 of electrical angle (in radians) versus time (in seconds) shows a relatively larger deviation 342 between an ideal angle and an actual angle for the conventional system, and, in FIG. 4(D), a graph 350 of electrical angle (in radians) versus time (in seconds) shows a relatively smaller deviation 352 between the ideal angle and the actual angle for exemplary embodiments. The discrepancy between the optimal and regulated angle corresponds to the deviation between the calculated and desired torque.

Referring to FIG. 5, the performance of the embodiment of the system 20 is compared with the performance of a conventional system for overall motor drive efficiency optimization for a variety of loadings. As seen in FIG. 5(A), a graph 420 of motor speed (in RPM) versus time (in seconds) shows relative performances from startup to a constant speed which is less than the transition speed of three hundred (300) RPM. With the motor operating at this constant speed, several different loads were applied and the current and the consumed motor drive power are shown. In FIG. 5(B), a graph 430 of current (in Amperes) versus time (in seconds) and in FIG. 5(C), a graph 440 of power consumption (in Watts) versus time (in seconds) show that exemplary embodiments minimize current and power consumption compared to the conventional technique, depending on the percentage of the load applied compared to the rated motor torque. In FIG. 5(D), a graph 450 of load torque (in Newton-meters) versus time (in seconds) shows the changing load applied to the motor, which resulted in the fluctuations of FIGS. 5(B) and (C).

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system comprising:
a sensorless motor drive configured to provide an output electric current to an electric motor; and
a closed-loop startup subsystem including—
a proportional integral closed-loop controller configured to determine an optimal electric current command to maintain a synchronization of the electric motor during a change in a speed of the electric motor,
the proportional integral closed-loop controller being configured to perform at least the following functions—
determine a power difference between an actual direct current power consumption of the electric motor and an ideal motor power output of the electric motor,
determine the optimal electric current command based on the power difference, and
apply the optimal electric current command to adjust the output electric current to the electric motor to reduce the power difference.

2. The system of claim 1, wherein the closed-loop startup subsystem only operates when a speed of the electric motor is between zero (0) revolutions per minute and four hundred (400) revolutions per minute.

3. The system of claim 2, wherein the integral closed-loop controller is configured, as part of determining the power difference, to perform the following operations—
measure the actual direct current power consumption on a direct current bus which is coupled with the electric motor;
determine an actual motor power output based on the actual direct current power consumption and a calculated converter and motor copper losses;
determine the ideal motor power output of the electric motor as a function of at least—
the output electric current from the sensorless motor drive,
a torque constant of the electric motor, and
a rotational speed of the electric motor, and
assuming that a rotor of the electric motor is running synchronously with a magnetic field within the electric motor; and
compare the actual motor power output to the ideal motor power output of the electric motor to determine the power difference.

4. The system of claim 3, the proportional integral closed-loop controller including—
an acceleration feedforward mechanism configured to determine an acceleration feedforward electric current component and add the acceleration feedforward electric current component to the output electric current of the proportional integral closed-loop controller,
wherein the acceleration feedforward current component is determined as a function of a mechanical system inertia, a rotating friction coefficient, a mechanical speed, and a torque constant of the electric motor, and
wherein the acceleration feedforward current component serves as a feedforward parameter that is adjusted to compensate for an effect of inertia and friction and thereby maintain a synchronization of the electric motor during the change in the speed of the electric motor.

5. The system of claim 4, the proportional integral closed-loop controller configured to add to the optimal electric current command a q-axis current offset of between three (3) and eight (8) percent of a maximum value of the output electric current.

6. The system of claim 1, wherein the integral closed-loop controller is configured, as part of determining the power difference, to perform the following operations—
measure the actual direct current power consumption on a direct current bus which is coupled with the electric motor;
determine an actual motor power output based on the actual direct current power consumption and a calculated converter and motor copper losses;
determine the ideal motor power output of the electric motor as a function of at least—
the output electric current from the sensorless motor drive,
a torque constant of the electric motor, and
a rotational speed of the electric motor, and
assuming that a rotor of the electric motor is running synchronously with a magnetic field within the electric motor; and
compare the actual motor power output to the ideal motor power output of the electric motor to determine the power difference.

7. The system of claim 1, the proportional integral closed-loop controller including—
an acceleration feedforward mechanism configured to determine an acceleration feedforward electric current component and add the acceleration feedforward electric current component to the output electric current of the proportional integral closed-loop controller,
wherein the acceleration feedforward current component is determined as a function of a mechanical system inertia, a rotating friction coefficient, a mechanical speed, and a torque constant of the electric motor, and
wherein the acceleration feedforward current component serves as a feedforward parameter that is adjusted to compensate for an effect of inertia and friction and thereby maintain a synchronization of the electric motor during the change in the speed of the electric motor.

8. The system of claim 1, the proportional integral closed-loop controller configured to add to the optimal electric current command a q-axis current offset of between three (3) and eight (8) percent of a maximum value of the output electric current.

9. A system comprising:
a permanent magnet electric motor including a rotor, a stator, and a shaft for driving a load;
a sensorless permanent magnet motor drive configured to provide an output electric current to the permanent magnet electric motor; and
a closed-loop startup subsystem including—
a proportional integral closed-loop controller configured to determine an optimal electric current command to maintain a synchronization of the permanent magnetic electric motor during a change in a speed of the permanent magnetic electric motor,
the proportional integral closed-loop controller being configured to perform at least the following functions—
determine a power difference between an actual direct current power consumption and an ideal motor power output of the permanent magnet electric motor,
determine the optimal electric current command based on the power difference, and
apply the optimal electric current command to adjust the output electric current to the permanent magnet electric motor to reduce the power difference.

10. The system of claim 9, wherein the closed-loop startup subsystem only operates when a speed of the permanent magnet electric motor is between zero (0) revolutions per minute and four hundred (400) revolutions per minute.

11. The system of claim 10, wherein the integral closed-loop controller is configured, as part of determining the power difference, to perform the following operations—
measure the actual direct current power consumption on a direct current bus which is coupled with the permanent magnet electric motor;
determine an actual motor power output based on the actual direct current power consumption and a calculated converter and motor copper losses;
determine the ideal motor power output of the permanent magnet electric motor as a function of at least—
the output electric current from the sensorless permanent magnet motor drive,
a torque constant of the permanent magnet electric motor, and
a rotational speed of the permanent magnet electric motor, and
assuming that a rotor of the permanent magnet electric motor is running synchronously with a magnetic field within the permanent magnet electric motor; and
compare the actual motor power output to the ideal motor power output of the permanent magnet electric motor to determine the power difference.

12. The system of claim 11, the proportional integral closed-loop controller including—
an acceleration feedforward mechanism configured to determine an acceleration feedforward electric current component and add the acceleration feedforward electric current component to the output electric current of the proportional integral closed-loop controller,
wherein the acceleration feedforward current component is determined as a function of a mechanical system inertia, a rotating friction coefficient, a mechanical speed, and a torque constant of the electric motor, and
wherein the acceleration feedforward current component serves as a feedforward parameter that is adjusted to compensate for an effect of inertia and friction and thereby maintain a synchronization of the electric motor during the change in the speed of the electric motor.

13. The system of claim 12, the proportional integral closed-loop controller adding to the optimal electric current command a q-axis current offset of between three (3) and eight (8) percent of a maximum value of the output electric current.

14. The system of claim 9, wherein the integral closed-loop controller is configured, as part of determining the power difference, to perform the following operations—
measure the actual direct current power consumption on a direct current bus which is coupled with the permanent magnet electric motor;
determine an actual motor power output based on the actual direct current power consumption and a calculated converter and motor copper losses;
determine the ideal motor power output of the permanent magnet electric motor as a function of at least—
the output electric current from the sensorless permanent magnet motor drive,
a torque constant of the permanent magnet electric motor, and
a rotational speed of the permanent magnet electric motor, and
assuming that a rotor of the permanent magnet electric motor is running synchronously with a magnetic field within the permanent magnet electric motor; and
compare the actual motor power output to the ideal motor power output of the permanent magnet electric motor to determine the power difference.

15. The system of claim 9, the proportional integral closed-loop controller including—
an acceleration feedforward mechanism configured to determine an acceleration feedforward electric current component and add the acceleration feedforward electric current component to the output electric current of the proportional integral closed-loop controller,
wherein the acceleration feedforward current component is determined as a function of a mechanical system inertia, a rotating friction coefficient, a mechanical speed, and a torque constant of the electric motor, and
wherein the acceleration feedforward current component serves as a feedforward parameter that is adjusted to compensate for an effect of inertia and friction and thereby maintain a synchronization of the electric motor during the change in the speed of the electric motor.

16. The system of claim 9, the proportional integral closed-loop controller adding to the optimal electric current command a q-axis current offset of between three (3) and eight (8) percent of a maximum value of the output electric current.

17. A method comprising:
providing an output electric current to an electric motor with a sensorless permanent magnet motor drive; and
adjusting the output electric current to the electric motor, wherein the operation of adjusting the output electric current includes—
determining an optimal electric current command to maintain a synchronization of the electric motor during a change in a speed of the electric motor, wherein the operation of determining the optimal electric current command includes—
determining a power difference between an actual motor power output and an ideal motor power output of the electric motor,
determining the optimal electric current command based on the power difference, and
applying the optimal electric current command to adjust the output electric current to the electric motor to reduce the power difference.

18. The method of claim 17, wherein adjusting the output electric current occurs only when a speed of the electric motor is between zero (0) revolutions per minute and four hundred (400) revolutions per minute.

19. The method of claim 17, wherein the operation of determining the power difference includes—
measuring the actual direct current power consumption on a direct current bus which is coupled with the electric motor;
determining the actual motor power output based on the actual direct current power consumption and a calculated converter and motor copper losses;
determining the ideal motor power output of the electric motor as a function of at least—
the output electric current from the sensorless motor drive,
a torque constant of the electric motor, and
a rotational speed of the electric motor, and
assuming that a rotor of the electric motor is running synchronously with a magnetic field within the electric motor; and
comparing the actual motor power output to the ideal motor power output of the electric motor to determine the power difference.

20. The method of claim 17, further including—
determining an acceleration feedforward electric current component and adding the acceleration feedforward electric current component to the output electric current,
wherein the acceleration feedforward current component is determined as a function of a mechanical system inertia, a rotating friction coefficient, a mechanical speed, and a torque constant of the electric motor, and
wherein the acceleration feedforward current component acts as a feedforward parameter that is adjusted to compensate for an effect of inertia and friction and thereby maintain a synchronization of the electric motor during the change in the speed of the electric motor.
